(19) United States
(12) Patent Application Publication
(10) Pub. No.: US 2010/0167239 A1
(43) Pub. Date: Jul. 1, 2010

(54) IMPRESSION DEVICE WITH IMPRESSION-TAKING CAP FOR DENTAL PROSTHESIS

(75) Inventor: Benoit Guillard, Grenoble (FR)

Correspondence Address: WILLIAM H. EILBERG, 316 CALIFORNIA AVE. #785, RENO, NV, 89509, US

(73) Assignee: ANTHOGYR, Sallanches (FR)

(21) Appl. No.: 12/515,515

(22) PCT Filed: Nov. 20, 2007
(86) PCT No.: PCT/IB2007/054716

§ 371 Date: Dec. 18, 2009

(30) Foreign Application Priority Data
Nov. 20, 2006 (FR) 06 55002

(51) Int. Cl. A61C 8/00; A61C 9/00; A61C 13/20

(52) U.S. Cl. 433/173; 433/214; 433/201.1

(57) ABSTRACT

An impression device includes an impression taking-cap (6) designed for adapting on an implant (1) or the like along one prosthetic bearing surface formed by a mount (2) and an annular peripheral shoulder (4). The impression taking-cap (6) includes an annular bearing surface (1) bearing on the annular peripheral shoulder (4) when placed in the mouth. The impression taking-cap (6) is maintained in this position by a retaining peg (13) extending axially from the bottom surface (8) in an inner chamber (9) and capable of axial engagement by friction in a retaining female geometry (2b) provided at the end of the mount (2). It is thus possible to insure an axial fixation of the impression taking-cap (6) on the implant (1) or the like and thus a very reliable impression taking of the annular peripheral shoulder (4), which results in the peripheral tightness of the prosthesis on the implant (1).

### TECHNICAL FIELD OF THE INVENTION

The present invention relates to devices for transferring, to a laboratory model, the shape and relative location of the surfaces of a dentition in the mouth of a patient.

The invention relates more specifically to such a device specially designed for transferring to the laboratory model the relative position of a prosthetic abutment for attaching a prosthesis to an implant that is already in position in a patient's mouth.

Dental implants are widely used for replacing damaged or lost natural teeth. For this purpose the practitioner places in the jaw of a patient an implant designed to replace the natural tooth root. Attached to the implant is an accommodating structure designed to extend out of the gingiva to accommodate and attach a dental prosthesis, and it is the latter which reproduces as faithfully as possible the shape and appearance of the natural tooth which it replaces. The dental prosthesis fits onto a prosthetic abutment, which is an appropriate region of the implant and/or of the accommodating structure, and which thus determines the relative position of the prosthesis in the mouth.

The final dental prosthesis must be configured and sized in such a way as to exactly fit with the remaining teeth of the patient's dentition, both esthetically and functionally. The creation of the dental prosthesis is a very long and painstaking process, which cannot therefore be done directly in the patient's mouth. The prosthesis is made in a laboratory by a prosthodontist, who needs a positive model reproducing as exactly as possible the shape of the patient's remaining dentition. The prosthodontist must also have, on the laboratory model, the exact shape and exact relative position of the prosthetic abutment, so that, once fabricated, the prosthesis will fit exactly onto the prosthetic abutment in the mouth and will in theory be in the appropriate position relative to the patient's other teeth.

It will be understood that accurate locating of the relative position of the prosthetic abutment in the patient's mouth is essential in order to avoid, as far as possible, subsequent operations of adjustment by machining the prosthesis in the patient's mouth.

To achieve this accuracy of location, a technique has been fine-tuned over recent years for taking impressions and making castings. The technique is as follows:

once the implant has been placed in the patient's mouth, with a projecting part forming a prosthetic attachment abutment for the subsequent attachment of a prosthesis, an impression-taking cap is fitted onto the prosthetic abutment;

an impression is taken of the patient's dentition using an impression material which overmolds the teeth and the impression-taking cap. Once cured, the impression material and the overmolded cap are removed, and these now have the negative form both of the patient's dentition and of the prosthetic abutment;

an analog casting component reproducing the shape of the prosthetic abutment and having an insertion body able to be overmolded by a casting material is inserted into the overmolded impression-taking cap;

the impression material and the impression-taking cap containing the analog casting component are used to fabricate a laboratory model from a casting material such as an appropriate plaster, and the casting material is allowed to set;

the casting material and the impression cap are removed, leaving a laboratory model that reproduces the positive shape of the dentition and of the prosthetic abutment.

The prosthodontist can then proceed to fabricate the dental prosthesis which will then be attached to the prosthetic abutment in the patient's mouth.

The prosthetic abutment for attaching a prosthesis to an implant usually comprises a mount which is designed to fit into a cavity in the prosthesis and is limited at its base by an annular peripheral shoulder. The impression-taking cap has a peripheral wall and a distal end wall defining a blind inner chamber which opens through a proximal orifice, the inner chamber being able to accommodate the mount of the prosthetic abutment.

The impression-taking cap must be retained satisfactorily on the prosthetic abutment in the patient's mouth during the taking of the impression. Similarly, the impression-taking cap must satisfactorily retain the analog casting component during fabrication of the laboratory model. However, the impression-taking cap must be able to be removed manually with the impression material from the prosthetic abutment after the impression material has cured in the patient's mouth, and the impression-taking cap must separate easily from the analog casting component after fabrication of the laboratory model. For this purpose a variety of means have already been devised to keep the impression-taking cap on a prosthetic abutment mount.

Traditionally, impression-taking caps have been retained by screwing them into the implant or into the mount while the impression was being taken in the mouth, and the analog casting component has been retained by screwing it into the impression-taking cap during fabrication of the laboratory model. The drawback of these systems is partly the extra time required to screw and unscrew the attachment means, and partly, and more significantly, the extra height required both because of the addition of the screw and more significantly because of the addition of the screwdriving tool, which makes the system difficult to operate in the mouth, especially in the molar region, and can result in inaccurate positioning.

Systems for the attachment of the impression-taking cap that are smaller and quicker have been described in the following documents.

Document U.S. Pat. No. 5,688,123 describes an impression-taking cap with resilient flaps at its base which snap onto a peripheral undercut part of a mount fitted to an implant.

Document WO 97/28755 describes an impression-taking cap having a lower peripheral edge that snaps onto the undercut periphery of the implant.

Document WO 03/037207 describes an impression-taking cap whose lower peripheral edge snaps into a groove around the periphery of the mount.

In the above devices, snap engagement occurs in an external peripheral zone of the prosthetic abutment, but the gingiva interferes with this zone. There is therefore a risk of a defective impression being taken due to imperfect snap engagement.

Document US 2006/228672 A1 describes an impression-taking cap having, in its inner chamber accommodating the mount of the prosthetic abutment, a retention pin able to engage axially with friction in a female retention geometry at the end of the mount. In all the embodiments illustrated, the retention pin comprises a blind axial hole and longitudinal slots defining flexible longitudinal tongues projecting radially and snap-engaging in an annular groove in the female retention geometry.

One problem with snap-engagement retention systems is that the snap-engagement function defines a unique axial orientation and unique axial position of the transfer cap on the prosthetic abutment, regardless of the axial orientation and relative axial position of the lower edge of the impression-taking cap with respect to the annular peripheral shoulder of the prosthetic abutment. But when the dental prosthesis is then placed in the mouth, it is important that the lower peripheral edge of the dental prosthesis coincides very closely with the annular peripheral shoulder of the prosthetic abutment, all the way around its periphery, in order to ensure a good seal. A defective seal would be a source of subsequent deterioration of the prosthesis over time.

Snap-engaging devices cannot therefore seal the prosthesis unless highly precise impression-taking caps are made that are perfectly adapted to the shape of the prosthetic abutments, which is difficult and costly to achieve.

### SUMMARY OF THE INVENTION

The problem addressed by the present invention is that of devising a novel device for retaining an impression-taking cap on a prosthetic abutment that avoids the drawbacks of the known devices and in particular gives more reliable positioning of the impression-taking cap so as to provide a good subsequent seal for the dental prosthesis.

The retention device according to the invention allows reversible manual engagement of the impression-taking cap with respect both to a prosthetic abutment for attachment to an implant and to an analog casting component for fabricating a laboratory casting.

The dimensions of the device are small, allowing an accurate impression to be taken in the mouth, even in the molar sector.

The device of the invention is quick and easy to use, and in particular requires no screwing or unscrewing.

The invention applies not only to an implant system using a prosthetic abutment on a single implant, but also to an implant system using a prosthetic abutment on a mount, as well as to an implant system using a prosthetic abutment supported on both an implant and a mount. In other words, the prosthetic abutment may be situated either on the implant, or on the mount, or partly on the mount and partly on the implant.

The invention also applies to the fabrication of prostheses having different attachment modes, particularly cement attachment, screw attachment, and snap attachment.

To achieve both these and other objects, the invention provides, in a first aspect, an impression-taking cap designed to engage with a prosthetic abutment of an implant or implant-prosthetic component assembly, the prosthetic abutment having a mount designed to fit into a cavity in a dental prosthesis and being limited at its base by an annular peripheral shoulder, the mount having a female retention geometry at its end, the impression-taking cap having a peripheral wall and a distal end wall defining a blind inner chamber which opens through a proximal orifice, the inner chamber being able to accommodate the mount and the annular peripheral shoulder of the prosthetic abutment, the impression-taking cap having an annular bearing facet around the proximal orifice and being shaped so as to abut axially against the annular peripheral shoulder of the prosthetic abutment, and the impression-taking cap comprising a retention pin extending axially within the inner chamber from the end wall and being able to engage axially with friction in the female retention geometry at the end of the mount, the retention pin comprising a male retention section having an outer peripheral surface in the shape of a cylinder of revolution capable of axial engagement in a female retention section of corresponding cylindrical surface belonging to the female retention geometry.

In this way the retention means of the impression-taking cap, which operate by friction only during an axial engagement, perform their retention role correctly irrespective of the axial position of the impression-taking cap with respect to the prosthetic attachment abutment, so that the practitioner can engage the impression-taking cap until its annular bearing facet meets the annular peripheral shoulder on the prosthetic abutment, and the impression-taking cap then stays in this position because of the friction retention means which, by means of the male and female cylindrical retention sections, provide a satisfactory retention force. The positioning of the impression-taking cap is reliable, and this ensures that there is subsequent good peripheral sealing of the prosthesis on the implant.

The practitioner ensures that the walls of the mount do not contact the walls of the impression-taking cap before the annular peripheral shoulder.

The inner chamber is preferably shaped to accommodate the mount with axial and radial play between the walls of the impression-taking cap and the mount when the annular bearing facet is in abutment against the annular peripheral shoulder of the prosthetic abutment. This promotes the contact of the impression-taking cap with the annular peripheral shoulder of the prosthetic abutment, such that the subsequent sealing of the prosthesis is still further enhanced.

Where transfer of the angular position of the prosthetic abutment is not necessary, the shape of the prosthetic abutment and/or the annular bearing facet of the impression-taking cap may be bodies of revolution.

Where transfer of the angular position of the prosthetic abutment is necessary, the inner chamber may according to the invention have shaped locking regions for preventing relative axial rotation by engaging with corresponding shaped regions on the mount.

The retention pin of the impression-taking cap is preferably dimensioned and structured in such a way that it engages by force in the female retention geometry of the mount, and that the frictional retention force between the retention pin and the female retention geometry of the mount is sufficient to withstand the pull-out forces during impression taking in the mouth and production of a laboratory model, yet allows reversible manual axial engagement of the impression-taking cap on the prosthetic abutment.

The retention pin may advantageously be in the shape of a cylinder of revolution. Such a shape is easy to cast, which facilitates the fabrication of an impression-taking cap. It also helps with manipulation when adapting or removing the impression-taking cap, because there is no need to match a particular angular orientation about the implant axis.

Alternatively, the male retention section of the retention pin may have an axial height much smaller than its diameter, and may in that case form a cylindrically topped projecting peripheral annular rib separated from the end wall by a reduced-diameter connecting section.

As a result, the retention means allow the impression-taking cap some capacity for angular deviation to either side of the direction of the longitudinal axis. The impression-taking cap can thus adapt more closely all the way around the periphery of the annular peripheral shoulder, thus further enhancing the subsequent sealing of the prosthesis. Simultaneously, the axial height of the male retention section determines the surface area of the rubbing area between the retention pin and the female retention geometry, making this surface independent of the axial position of the impression-taking cap on the prosthetic abutment. This provides better control of the axial retaining force of the impression-taking cap on the prosthetic abutment.

The impression-taking cap preferably comprises a flared external peripheral rim suitable for keeping the gingiva out of the way during placement of the impression-taking cap on the implant. As a result, when the impression-taking cap is placed on the prosthetic attachment abutment, interposition of the gingiva is avoided. Such interposition would interfere with the accuracy of the transfer, especially in the prosthesis sealing region. The use of a retraction cord, a technique that has long been used but is poorly compatible with some implant materials, is simultaneously avoided.

Another aspect of the invention is that it provides a dental implant suitable for engagement with an impression-taking cap and having a prosthetic abutment for attachment of a dental prosthesis, the prosthetic abutment having a mount designed to fit into a cavity in the prosthesis and being limited at its base by an annular peripheral shoulder, the impression-taking cap having a peripheral wall and a distal end wall defining a blind inner chamber which opens through a proximal orifice, the inner chamber being able to accommodate the mount and the annular peripheral shoulder of the prosthetic abutment, the dental implant comprising, at its distal end, a female retention geometry suitable for accommodating axially with friction a retention pin provided in the inner chamber of the impression-taking cap, and the female retention geometry comprising a female retention section with a cylindrical inside surface suitable for accommodating by axial engagement a male retention section of the retention pin.

With this arrangement the implant is suitable for accommodating the impression-taking cap defined above, and the whole assembly allows reliable transfer of the position of the prosthetic abutment to a laboratory model.

When using an impression-taking cap where the retention pin is cylindrical, it is preferable for the female retention section to have an axial height that is preferably much less than its diameter, the female retention section forming a projecting inner annular rib separated from the end wall of the female retention geometry by a section of female retention geometry where the diameter is increased by an undercut. The effects obtained are similar to those obtained with a male retention section of predetermined axial height.

In accordance with another aspect, the invention provides a prosthetic component suitable for forming with an implant a prosthetic abutment having a mount designed to fit into a cavity in the prosthesis and being limited at its base by an annular peripheral shoulder, the whole being able to engage with an impression-taking cap having a peripheral wall and a distal end wall defining a blind inner chamber which opens through a proximal orifice, the inner chamber being able to accommodate the mount and the annular peripheral shoulder of the prosthetic abutment, the prosthetic component comprising, at its distal end, a female geometry of retention able to accommodate axially with friction a retention pin provided in the inner chamber of the impression-taking cap, and the female retention geometry comprising a female retention section having a cylindrical inside surface able to accommodate by axial engagement a male retention section of the retention pin.

When using an impression-taking cap where the retention pin is cylindrical, it is preferable for the female retention section to have an axial height that is preferably much less than its diameter, the female retention section forming a projecting inner annular rib separated from the end wall of the female retention geometry by a section of female retention geometry where the diameter is increased by an undercut.

As a result, the retention means allow the impression-taking cap some capacity for angular deviation to either side of the direction of the longitudinal axis. The impression-taking cap can thus adapt more closely all the way around the periphery of the annular peripheral shoulder, thus further enhancing the subsequent sealing of the prosthesis. Also, the female retention section of predetermined height determines the retention force on the impression-taking cap.

As in the case of the one-piece implant mount, the female retention section may have an inside surface that is a cylinder of revolution with longitudinal grooves arranged at regular intervals around the female retention geometry.

In accordance with another aspect, the invention provides an analog casting component able to reproduce the exact shape of a prosthetic abutment with a mount and an annular peripheral shoulder in a laboratory model, comprising an insertion body able to be overmolded by a casting material and surmounted by a protuberance having the outside shape of the mount and limited at its base by a shoulder having the relative position and outside shape of the annular peripheral shoulder of the prosthetic abutment, the distal part of the protuberance comprising a female retention geometry able to accommodate axially with friction a retention pin provided in the inner chamber of an impression-taking cap; according to the invention, the female retention geometry comprises a female retention section with a cylindrical inside surface able to accommodate by axial engagement a male retention section of the retention pin.

When using an impression-taking cap where the retention pin is cylindrical, it is preferable for the female retention section to have an axial height that is preferably much less than its diameter, the female retention section forming a projecting inner annular rib separated from the end wall of the female retention geometry by a section of female retention geometry where the diameter is increased by an undercut.

As a result, the retention means allow the impression-taking cap some capacity for angular deviation to either side of the direction of the longitudinal axis. The impression-taking cap can thus adapt more closely all the way around the periphery of the annular peripheral shoulder, thus further enhancing the subsequent sealing of the prosthesis. Also, by means of this structure the retaining force of the impression-taking cap on the prosthetic abutment is further controlled.

As in the case of the one-piece implant mount, the female retention section of the analog casting component may have an inside surface that is a cylinder of revolution with longitudinal grooves arranged at regular intervals around the female retention geometry.

In accordance with another aspect, the invention provides an impression assembly with impression-taking cap for transferring to a laboratory model the relative position of the prosthetic abutment for attaching a prosthesis to an implant in position in the mouth, comprising:

an impression-taking cap as defined above,

an implant as defined above and/or a prosthetic component as defined above, and

an analog casting component as defined above.

### BRIEF DESCRIPTION OF THE DRAWINGS

Other objects, features and advantages of the present invention will become apparent in the course of the following description of particular embodiments. The description refers to the attached drawings, in which:

FIGS. 1 to 3 illustrate three known embodiments of a prosthetic abutment for attaching a prosthesis to an implant;

FIG. 4 is a side view of an implant or analog-impression-taking cap assembly in a first embodiment of the present invention;

FIG. 5 is a diametrical cross section through the implant or analog-impression-taking cap assembly of FIG. 4;

FIG. 6 is a side view of an implant-prosthetic component-impression-taking cap assembly, illustrating a second embodiment of the present invention;

FIG. 7 is a diametrical cross section through the assembly of FIG. 6;

FIGS. 8, 9, 10 and 11 are transverse cross sections through four embodiments of the corresponding lateral surfaces of the female retention geometry and of the retention pin; and

FIG. 12 is a longitudinal cross section through the means for retaining the impression-taking cap on a prosthetic abutment, in another embodiment.

### DESCRIPTION OF THE PREFERRED EMBODIMENTS

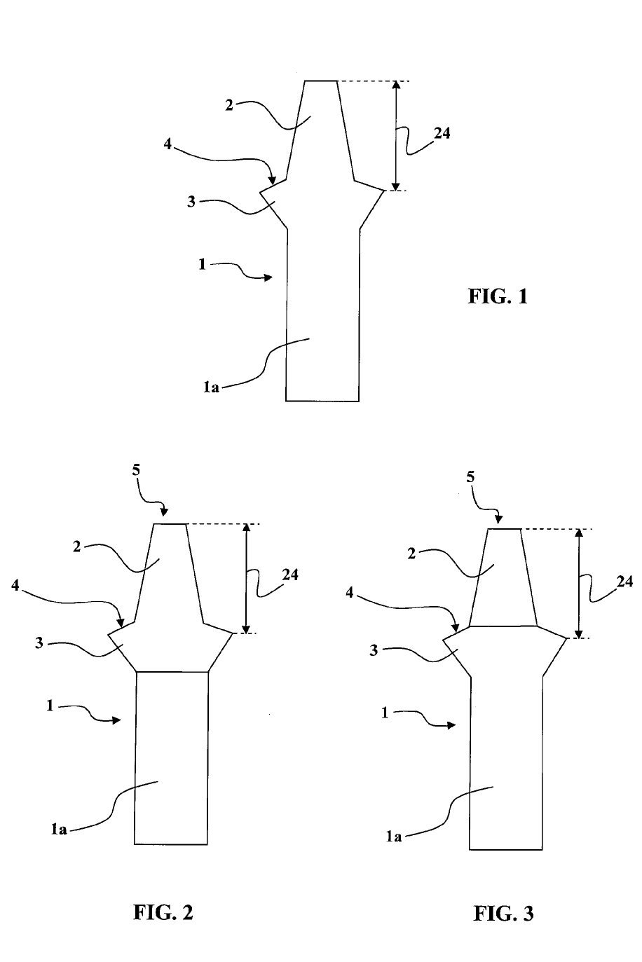

FIGS. 1 to 3 will be considered first: these illustrate three embodiments to which the present invention can be applied, of a prosthetic abutment for the attachment of a prosthesis.

FIG. 1, which is a side view, shows a one-piece implant 1 with an attachment base 1a, a mount 2, and an intermediate annular peripheral rib 3, one face of which is oriented toward the mount 2 and defines an inclined annular peripheral shoulder 4 limiting the base of the mount 2.

The same external shape appears in FIG. 2, except that the whole is made up of two parts fitted together, comprising the implant 1 (consisting only of the attachment base 1a of FIG. 1), and a prosthetic component 5 which itself forms the mount 2 and the inclined annular peripheral shoulder 4.

In FIG. 3 the assembly is again composed of two components, the implant 1 again comprising the attachment base 1a and also the intermediate annular peripheral rib 3 forming the inclined annular peripheral shoulder 4, while the prosthetic component 5 comprises the mount 2 only.

The invention can be applied equally satisfactorily to any of the three embodiments illustrated in FIGS. 1-3.

In the three embodiments, the segment 24 consisting of the mount 2 and the inclined annular peripheral shoulder 4 constitutes the prosthetic abutment for attaching a prosthesis to the implant, i.e. the surface designed to provide correct positioning and attachment of the dental prosthesis which will subsequently be attached to the implant.

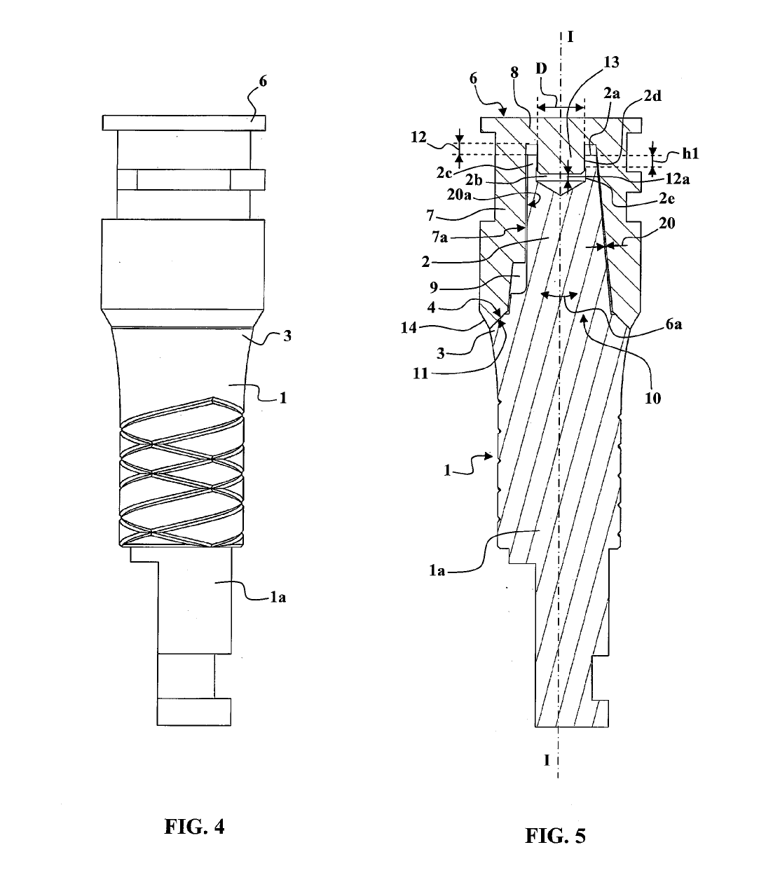

Turning now to FIGS. 4 and 5, these show a first embodiment of the invention. This first embodiment corresponds to a one-piece implant in accordance with FIG. 1, or to a one-piece analog casting component. This once again has an attachment base 1a, a mount 2 (FIG. 5), and an intermediate annular peripheral rib 3 defining an inclined annular peripheral shoulder 4 (FIG. 5).

The external lateral surface of the attachment base 1a is structured in a known way to enable it to be anchored in position. In the embodiment illustrated, it is analog casting component designed to be used with an impression material. In this case, the external lateral surface of the attachment base 1a comprises, as illustrated, deep undercuts suitable for ensuring satisfactory anchorage in an impression material.

In the case of an implant, the external lateral surface of the attachment base 1a comprises, as is known, striations suitable for firm anchorage when impacted into a corresponding hole prepared in the bone of a jaw, or screwthreads. Only the external lateral surfaces of the attachment base 1a differ, depending on whether the base is an implant or an analog casting component.

As can be seen in FIG. 5, the distal end 2a of the mount 2 that is the end directed away from the attachment base 1a, comprises a female retention geometry 2b in the form of an axial hole which opens onto the end face and is limited by a side wall parallel to the longitudinal axis I-I of the mount 2.

An impression-taking cap 6 can be fitted to the prosthetic attachment abutment represented by the mount 2 and by the inclined annular peripheral shoulder 4, as shown in FIG. 5.

As FIG. 4 shows, the peripheral outer surface of the impression-taking cap 6 is specially shaped to enable it to be anchored in an impression-taking material which is overmolded onto it when the impression is taken in the mouth. The anchorage ensures that the impression-taking cap does not separate from the impression-taking material once the latter is cured.

As FIG. 5 shows, the impression-taking cap 6 comprises a peripheral wall 7 and a distal end wall 8 which together define a blind inner chamber 9 which opens through a proximal orifice 10. The inner chamber 9 is able to accommodate the whole of the mount 2 and the annular peripheral shoulder 4 of the prosthetic abutment 24.

The impression-taking cap 6 also comprises an annular bearing facet 11 around the proximal orifice 10: this facet 11 may advantageously form a complementary surface for the annular peripheral shoulder 4 of the prosthetic abutment 24.

It will be seen that, when the impression-taking cap 6 is fitted in position on the implant 1 or analog casting component in this embodiment, with the annular bearing facet 11 placed against the annular peripheral shoulder 4, there is an axial clearance 12, and a slight radial gap 20, between the outer surface of the mount 2 and the inside surface of the walls of the impression-taking cap 6.

The impression-taking cap 6 further comprises a retention pin 13 extending axially within the inner chamber 9 from the end wall 8 and being shaped to engage axially with friction in the female retention geometry 2b of the mount 2. In this way a female retention geometry 2b on the end of the mount 2 accommodates and axially retains by friction alone the retention pin 13 and the impression-taking cap 6.

In the embodiment illustrated in FIG. 5, the retention pin 13 is a cylinder of revolution. It is easy to fabricate. Positioning it is also easy because it requires no angular indexing around the axis I-I.

In accordance with one possibility, the female retention geometry 2b may also be in the shape of a body of revolution complementary to the shape of the retention pin 13.

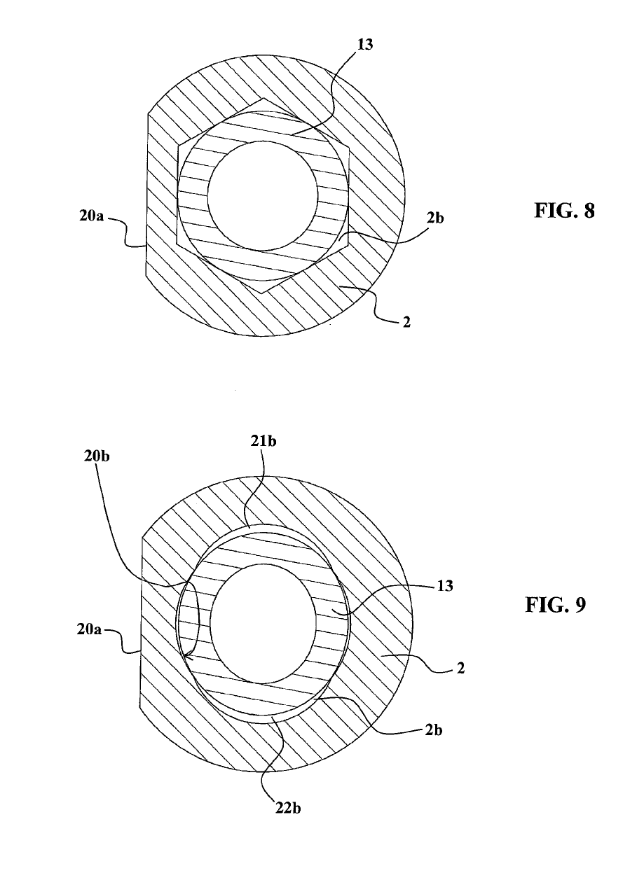

However, as an alternative, and as illustrated in transverse cross section in FIG. 8, the female retention geometry 2b may have a polygonal transverse cross section into which the cylindrical shape of the retention pin 13 can also be inserted with friction.

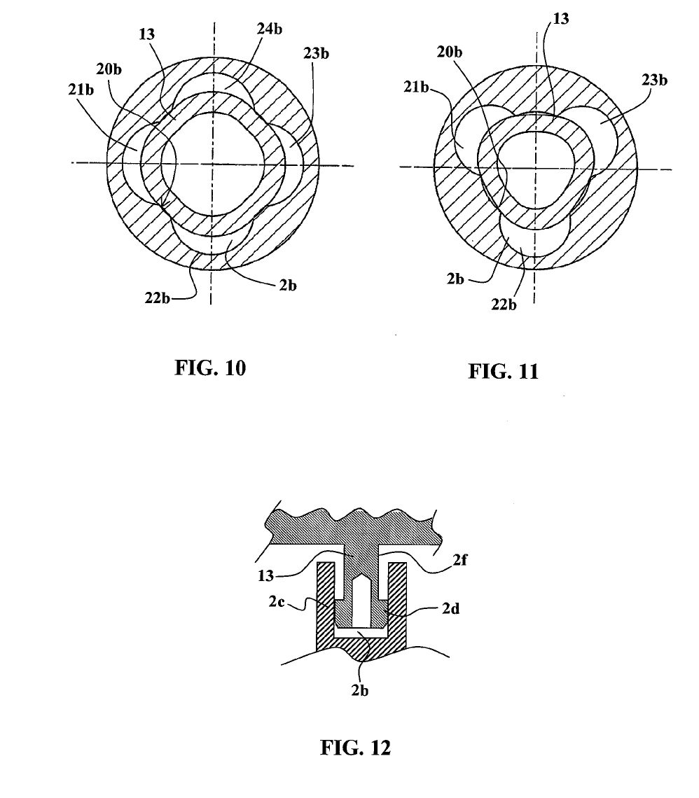

In various advantageous embodiments illustrated in FIGS. 9, 10 and 11 in transverse cross section, the female retention geometry 2b may have, at least in the female retention section 2c a cylindrical inside surface of revolution 20b with longitudinal grooves 21b, 22b, 23b and 24b arranged at regular intervals around the female retention geometry 2b. FIG. 9 shows an embodiment with two diametrically opposite longitudinal grooves 21b and 22b whose transverse profiles are circular arcs. FIG. 10 shows an embodiment with four longitudinal grooves 21b, 22b, 23b and 24b arranged at 90° intervals and having transverse profiles in the form of circular arcs. FIG. 11 shows an embodiment with three longitudinal grooves 21b, 22b and 23b arranged at 120° intervals and having transverse profiles in the form of circular arcs. Such grooves whose profiles are circular arcs are easy to produce. The out-of-center positions and the radii of the circles are selected in such a way as to preserve sufficient bearing areas in the cylindrical surface 20b.

In these cases, the female retention geometry 2b contacts the retention pin 13 along a plurality of rubbing regions of small surface area separated by voids (the grooves 21b-24b) which reduce the radial rigidity of the frictional assembly, as a result of the radial deformation of the retention pin 13, as can be seen in the figures. The force required to assemble and withdraw the impression-taking cap 6 is thus controlled better and made more constant and reproducible.

The depth of the female retention geometry 2b, or length along the longitudinal axis I-I is sufficient for the retention pin 13 to enter without its end touching the end wall of the female retention geometry 2b when the impression-taking cap 6 is in the impression-taking position shown in FIG. 5. It can thus be seen in FIG. 5 that when the impression-taking cap 6 is in position on the implant 1, with the annular bearing facet 11 pressed against the annular peripheral shoulder 4, there is an axial gap 12a between the top of the retention pin 13 and the end wall of the female retention geometry 2b. The gaps 12, 12a and 20 ensure that the impression-taking cap is in contact via its annular facet 11 with the annular peripheral shoulder 4 when the practitioner pushes it axially towards the implant 1.

The female retention geometry 2b as illustrated comprises a female retention section 2c that has, along the longitudinal axis I-I, a defined axial height h1. A section 2e of increased diameter separates the end wall of the female retention geometry 2b from the female retention section 2c, so that the female retention section 2c forms a projecting inward annular rib, whose cylindrical top is engaged on the cylindrical side wall of the retention pin 13. This provides good control of the frictional retaining force of the impression-taking cap 6 on the mount 2. In particular, this retaining force is not dependent on any dispersion of the relative axial positions of the annular peripheral shoulder 4 and of the distal end 2a of the mount 2.

The axial height h1 of the female retention section 2c is preferably much less than its diameter D, e.g. less than one fourth of its diameter D. This provides the capability of a slight angular deviation of the impression-taking cap 6 away from the direction of the longitudinal axis I-I, as shown by the double arrow 6a. The impression-taking cap 6 can thus be fitted more closely around the periphery of the annular peripheral shoulder 4, to further enhance the subsequent sealing of the prosthesis.

The diameter D of the female retention section 2c, which is equal (if functional play is disregarded) to the diameter of the retention pin 13, may advantageously be chosen to be much less than the diameter of the mount 2 in order to further improve the capability of angular deviation 6a of the impression-taking cap 6 away from the direction of the longitudinal axis I-I.

As an alternative to the embodiment illustrated having a female retention section 2c in the form of a projecting inward annular rib engaging on a cylindrical retention pin 13, the invention allows, as illustrated in FIG. 12, a cylindrical or prismatic female retention geometry 2b engaging around a cylindrical retention pin 13 which itself has a male retention section 2d forming a projecting peripheral annular rib and an undercut reduced-diameter connecting section 2f.

The impression-taking cap 6 as illustrated in FIG. 5 also comprises a flared external peripheral rim 14, suitable for keeping the gingiva out of the way during placement of the impression-taking cap 6 on the implant 1 in the patient's mouth.

In the embodiment illustrated in FIG. 5, the implant 1 (or the analog casting component) is thus in itself able to accommodate the impression-taking cap 6, and it comprises, at its distal end, the female retention geometry 2b which is able to accommodate axially with friction the retention pin 13 formed in the inner chamber 9 of the impression-taking cap 6.

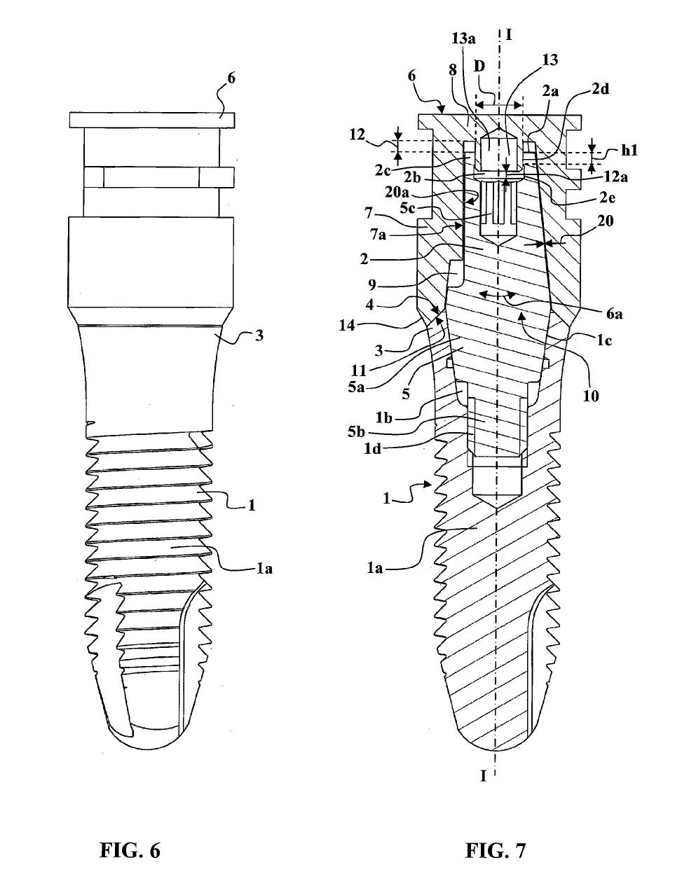

Referring now to FIGS. 6 and 7, these show an implant 1 in another embodiment of the invention designed for a screw attachment, and accommodating a prosthetic component 5 as described earlier in relation to FIG. 3.

FIG. 7 shows in cross section the implant 1 which comprises the retention base 1a and the outer intermediate annular peripheral rib 3 whose distal face defines the inclined annular peripheral shoulder 4.

The prosthetic component 5 meanwhile comprises the mount 2 and is fitted into the implant 1.

For this purpose the implant 1 comprises an assembly cavity 1b comprising a conical section 1c and a threaded axial hole 1d for accommodating and attaching a conical attachment body 5a and a threaded attachment stem 5b of the prosthetic component 5. The prosthetic component 5 is attached into the implant 1 by a screwing action, and so that it can be driven, the prosthetic component 5 comprises an axial driving cavity 5c which is accessible from the end 2a of the mount 2.

Once the prosthetic component 5 has been assembled on the implant 1, the whole forms a component similar to the one-piece implant 1 shown in FIG. 5.

The outer surface of the attachment base 1a comprises a self-tapping thread suitable for fixing the implant in the bone by a screwing action.

The external shape of the prosthetic abutment 24, which again consists in the FIG. 7 embodiment of the mount 2 and the inclined annular peripheral shoulder 4, is the same as the external shape in the preceding embodiment, FIG. 5. The same impression-taking cap 6, with the same shape as described above, can thus be used on the implant 1-prosthetic component 5 assembly as seen in FIG. 7.

The same elements are thus present as in the embodiment shown in FIG. 5, and are identified by the same reference numbers, so they will not be described again.

In particular, the impression-taking cap 6 fits around the mount 2 with an axial clearance 12 and a radial gap 20, with its annular bearing facet 11 resting on the inclined annular peripheral shoulder 4. It is held in position by the retention pin 13 engaged with friction in the female retention geometry 2b of the mount 2.

The driving cavity 5c continues the female retention geometry 2b toward the attachment base 1a and its diameter is smaller than that of the female retention geometry 2b.

In the embodiment shown in FIG. 7, the prosthetic component 5 is thus able to form with the implant 1 a prosthetic abutment 24 to engage with the impression-taking cap 6 and with the subsequently fabricated prosthesis, and the prosthetic component 5 comprises, at its distal end, the female retention geometry 2b which is able to accommodate axially with friction the retention pin 13 present in the inner chamber 9 of the impression-taking cap 6.

In this embodiment, the conical fitting together (conical section 1c) of the implant 1 and the prosthetic component 5 causes, owing to manufacturing tolerances, a dispersion in the axial position of relative locking of the prosthetic component 5 in the implant 1. Since the annular peripheral shoulder 4 is here formed by the implant 1, while the female retention geometry 2b is formed by the prosthetic component 5, the penetration of the retention pin 13 into the female retention geometry 2b can vary. It is therefore highly advantageous to have a retention structure with a female retention section 2c, which determines and keeps constant the rubbing surface which produces the retention force, regardless of how far the retention pin 13 may penetrate.

In the illustrated embodiment, the impression-taking cap 6 comprises the hollow retention pin 13 with a blind axial hole 13a which is open in the inward direction and defines a tubular structure. The advantage is that a tubular structure of this kind is, because of the reduced thickness of its wall, elastically deformable under radial stress. Such radial elastic deformation is illustrated in FIGS. 9, 10 and 11, where the retention pin 13 is deformed radially to fit the non-circular outline of the female retention geometry 2b, by pressing against the cylindrical portions of the surface 20b, and engaging in the longitudinal grooves 21b, 22b, 23b, 24b.

The elasticity of the tubular structure of such a retention pin 13 has two advantageous effects. The first effect is that it compensates for potential dispersions in the respective radial dimensions of the retention pin 13 and of the female retention geometry 2b, in order to ensure that the frictional retention force is kept within a range of acceptable values.

The second effect is also to give the impression-taking cap 6 a capacity for slight angular deviation 6a away from the direction of the longitudinal axis I-I. The impression-taking cap 6 can thus fit even more closely all the way around the periphery of the annular peripheral shoulder 4, thus further enhancing the subsequent sealing of the prosthesis.

The implant 1 as illustrated in the preceding figures, in the one-piece variant shown in FIG. 5 or in the variant with the prosthetic component in FIG. 7, combined with an impression-taking cap 6, allows precise location of the position of the annular peripheral shoulder 4 in the patient's mouth. To this end the impression-taking cap 6 is fitted axially with force onto the prosthetic abutment 24, that is to say onto the mount 2 and the annular peripheral shoulder 4, after which an impression-taking material is applied around the impression-taking cap 6 and around the patient's teeth. After the impression-taking material has set, it is removed, care being taken to simultaneously remove the impression-taking cap 6 from the implant 1.

A positive model reproducing the shape of the dentition of the patient and the shape and position of the projecting part of the implant 1 formed by the prosthetic abutment 24 must then be produced in the laboratory.

For this purpose an analog casting component 1 such as that illustrated in FIGS. 4 and 5, is used. This has the exact external shape of the prosthetic abutment of the mount 2 and annular peripheral shoulder 4 of an implant or implant-prosthetic component assembly present in the patient's mouth. The analog casting component 1 is a prefabricated component in the exact shape of the prosthetic abutment of the implant which the practitioner has selected to insert into the patient's mouth.

This analog casting component 1 thus comprises an insertion body able to be overmolded by an impression material, the insertion body being capped by a protuberance having the external shape of the mount 2, limited at its base by a shoulder having the relative position and external shape of the annular peripheral shoulder 4 of the prosthetic abutment 24.

Additionally, the distal part of the protuberance comprises a female retention geometry 2b that is able to accommodate axially with friction the retention pin 13 of the impression-taking cap 6, and that preferably comprises a female retention section 2c and a section 2e of increased diameter.

Hence, in the laboratory, the analog casting component is fitted into the inner chamber 9 of the impression-taking cap 6, which in turn is partially or completely embedded in the impression-taking material, until the retention pin 13 is inserted axially with force into the female retention geometry 2b of the analog casting component and until the annular peripheral shoulder of the analog casting component engages against the annular bearing facet 11 of the impression-taking cap 6.

Next, a casting material such as plaster is applied to make the positive casting reproducing the shape of the patient's dentition. When the impression-taking cap 6 is removed, the analog casting component is correctly positioned with respect to the casting parts reproducing the dentition, and the prosthodontist can make the dental prosthesis which will subsequently be fitted exactly to the prosthetic abutment 24 in the patient's mouth.

In the embodiments depicted in FIGS. 5 and 7, the device is also designed to prevent relative axial rotation of the impression-taking cap 6 on the implant 1. For this purpose the inner chamber 9 is limited by a portion of the peripheral wall 7 which is in the form of a flat 7a, while the peripheral wall of the mount 2 also comprises a complementary flat 20a.

In the embodiments depicted in the figures, the annular peripheral shoulder 4 is a frustoconical body of revolution whose top is oriented toward the distal end of the implant 1 or prosthetic component 5. The invention however applies to all other forms of annular peripheral shoulders able to perform the function of axial abutment and the function of peripheral sealing of the prosthesis.

In the embodiments illustrated, the impression-taking cap 6 is a one-piece component with a peripheral wall 7 and an end wall 8, both of which are solid.

However, the invention also applies to impression-taking caps made by fitting together multiple components, such as with a retention pin 13 in the form of a separate component attached to a cap body forming the peripheral wall, or in the form of an added end wall 8 comprising a retention pin 13.

This can be illustrated in FIGS. 5 and 7, taking the retention pin 13 to be a cylindrical component that continues as far as the upper face of the impression-taking cap 6 as shown by the dashes marking the diameter D.

Making an impression-taking cap by joining together two components can be easier and more accurate. Specifically, it allows more precise control over the size of the retention pin 13, because it can be controlled before assembly. The size of the retention pin 13 has a very considerable influence on the retention force of the impression-taking cap.

On the other hand, because of the very small dimensions of an impression-taking cap, the dimensional control of the retention pin 13 is very difficult if the retention pin is in place in the inner chamber of the impression-taking cap.

For instance, the impression-taking cap 6 can be made from a machined plastic such as medical-grade polycarbonate. The retention pin 13 may have an inside diameter of about 1.1 mm, and an outside diameter D of 1.72 mm (+0.02-0). At the same time, the female retention geometry 2b may have a nominal diameter of 1.65 mm (+0.01-0), with longitudinal grooves, and the female retention section 2c may have an axial height h1 of about 0.3 mm.

The invention also applies to impression-taking caps having in their walls one or more orifices allowing the impression-taking product to penetrate around the prosthetic abutment. Such a configuration allows any retouching of this prosthetic abutment to be taken into account.

The present invention is not limited to the embodiments that have been explicitly described. Rather, it includes the various variants and the generalizations contained in the scope of the following claims.

1. Impression-taking cap (6) designed to engage with a prosthetic abutment (24) of an implant (1) or implant (1)-prosthetic component (5) assembly, the prosthetic abutment (24) having a mount (2) designed to fit into a cavity in a dental prosthesis and being limited at its base by an annular peripheral shoulder (4), the mount (2) having a female retention geometry (2b) at its end, the impression-taking cap (6) having a peripheral wall (7) and a distal end wall (8) defining a blind inner chamber (9) which opens through a proximal orifice (10), the inner chamber (9) being able to accommodate the mount (2) and the annular peripheral shoulder (4) of the prosthetic abutment (24), the impression-taking cap (6) having an annular bearing facet (11) around the proximal orifice (10) and being shaped so as to abut axially against the annular peripheral shoulder (4) of the prosthetic abutment (24), and the impression-taking cap comprising a retention pin (13) extending axially within the inner chamber (9) from the end wall (8) and being able to engage axially with friction in the female retention geometry (2b) at the end of the mount (2), wherein the retention pin (13) comprises a male retention section (2d) having an outer peripheral surface in the shape of a cylinder of revolution capable of axial engagement in a female retention section (2c) of corresponding cylindrical surface belonging to the female retention geometry (2b).

2. Impression-taking cap (6) according to claim 1, wherein the retention pin (13) of the impression-taking cap (6) is dimensioned and structured in such a way that it engages by force in the female retention geometry (2b) of the mount (2), and that the frictional retention force between the retention pin (13) and the female retention geometry (2b) of the mount (2) is sufficient to withstand the pull-out forces during impression taking in the mouth and production of a laboratory model, yet allows reversible manual axial engagement of the impression-taking cap (6) on the prosthetic abutment (24).

3. Impression-taking cap (6) according to claim 1, wherein the inner chamber (9) has shaped locking regions (7a) for preventing relative axial rotation by engaging with corresponding shaped regions (20a) on the mount (2).

4. Impression-taking cap (6) according to claim 1, wherein the inner chamber (9) is shaped to accommodate the mount (2) with axial and radial clearance (12, 20) between the walls of the impression-taking cap (6) and the mount (2) when the annular bearing facet (11) is in abutment against the annular peripheral shoulder (4) of the prosthetic abutment (24).

5. Impression-taking cap (6) according to claim 1, wherein the male retention section of the retention pin (13) has an axial height much smaller than its diameter, and forms a cylindrically topped projecting peripheral annular rib separated from the end wall (8) by a reduced-diameter connecting section (2f).

6. Impression-taking cap (6) according to claim 1, wherein the retention pin (13) comprises an inwardly open blind axial hole (13a) defining an elastically deformable tubular structure.

7. Impression-taking cap (6) according to claim 1, wherein the retention pin (13) is a separate component fixed to a cap body forming the peripheral wall (7).

8. Impression-taking cap (6) according to claim 1, wherein it comprises a flared external peripheral rim (14) suitable for keeping the gingiva out of the way during placement of the impression-taking cap (6) on the implant (1).

9. Dental implant (1) suitable for engagement with an impression-taking cap (6) and having a prosthetic abutment (24) for attachment of a dental prosthesis, the prosthetic abutment (24) having a mount (2) designed to fit into a cavity in the prosthesis and being limited at its base by an annular peripheral shoulder (4), the impression-taking cap (6) having a peripheral wall (7) and a distal end wall (8) defining a blind inner chamber (9) which opens through a proximal orifice (10), the inner chamber (9) being able to accommodate the mount (2) and the annular peripheral shoulder (4) of the prosthetic abutment (24), and the dental implant comprising, at its distal end, a female retention geometry (2b) suitable for accommodating axially with friction a retention pin (13) provided in the inner chamber (9) of the impression-taking cap (6), the female retention geometry (2b) comprising a female retention section (2c) with a cylindrical inside surface (20b) suitable for accommodating by axial engagement a male retention section (2d) of the retention pin (13).

10. Implant according to claim 9, wherein the female retention section (2c) has an axial height (h1) that is preferably much less than its diameter (D), the female retention section (2c) forming a projecting inner annular rib separated from the end wall of the female retention geometry (2b) by a section (2e) of female retention geometry (2b) where the diameter is increased by an undercut.

11. Implant according to claim 9, wherein the female retention section (2c) has an inside surface (20b) that is a cylinder of revolution with longitudinal grooves (21b, 22b, 23b, 24b) arranged at regular intervals around the female retention geometry (2b).

12. Prosthetic component (5) suitable for forming with an implant (1) a prosthetic abutment (24) having a mount (2) designed to fit into a cavity in the prosthesis and being limited at its base by an annular peripheral shoulder (4), the whole being able to engage with an impression-taking cap (6) having a peripheral wall (7) and a distal end wall (8) defining a blind inner chamber (9) which opens through a proximal orifice (10), the inner chamber (9) being able to accommodate the mount (2) and the annular peripheral shoulder (4) of the prosthetic abutment (24), and the prosthetic component (5) comprising, at its distal end, a female geometry of retention (2b) able to accommodate axially with friction a retention pin (13) provided in the inner chamber (9) of the impression-taking cap (6), wherein the female retention geometry (2b) comprising a female retention section (2c) having a cylindrical inside surface (20b) able to accommodate by axial engagement a male retention section (2d) of the retention pin (13).

13. Prosthetic component (5) according to claim 12, wherein the female retention section (2c) has an axial height (h1) that is preferably much less than its diameter (D), the female retention section (2c) forming a projecting inner annular rib separated from the end wall of the female retention geometry (2b) by a section (2e) of female retention geometry (2b) where the diameter is increased by an undercut.

14. Prosthetic component (5) according to claim 12, wherein the female retention section (2c) has an inside surface (20b) that is a cylinder of revolution with longitudinal grooves (21b, 22b, 23b, 24b) arranged at regular intervals around the female retention geometry (2b).

15. Analog casting component (1) able to reproduce the exact shape of a prosthetic abutment (24) with a mount (2) and an annular peripheral shoulder (4) in a laboratory model, the analog casting component (1) comprising an insertion body (1a) able to be overmolded by a casting material and surmounted by a protuberance having the outside shape of the mount (2) and limited at its base by a shoulder having the relative position and outside shape of the annular peripheral shoulder (4) of the prosthetic abutment (24), the distal part of the protuberance comprising a female retention geometry (2b) able to accommodate axially with friction a retention pin (13) provided in the inner chamber (9) of an impression-taking cap (6), the female retention geometry (2b) comprising a female retention section (2c) with a cylindrical inside surface (20b) able to accommodate by axial engagement a male retention section (2d) of the retention pin (13).

16. Analog casting component according to claim 15, wherein the female retention section (2c) has an axial height (h1) that is preferably much less than its diameter (D), the female retention section (2c) forming a projecting inner annular rib separated from the end wall of the female retention geometry (2b) by a section (2e) of female retention geometry (2b) where the diameter is increased by an undercut.

17. Analog casting component according to claim 15, wherein the female retention section (2c) has an inside surface (20b) that is a cylinder of revolution with longitudinal grooves (21b, 22b, 23b, 24b) arranged at regular intervals around the female retention geometry (2b).

18. Impression assembly with impression-taking cap for transferring to a laboratory model the relative position of the prosthetic abutment (24) for attaching a prosthesis to an implant (1) in position in the mouth, comprising:
an impression-taking cap (6) according to claim 1,
an implant (1) according to claim 9 and/or a prosthetic component (5) according to claim 12, and
an analog casting component according to claim 15.
